(19) United States
(12) Patent Application Publication
(10) Pub. No.: US 2013/0068950 A1
(43) Pub. Date: Mar. 21, 2013

(54) 3D EYEGLASS

(71) Applicant: Hae-Yong CHOI, Seoul-city (KR)

(72) Inventor: Hae-Yong CHOI, Seoul-city (KR)

(21) Appl. No.: 13/238,118

(22) Filed: Sep. 21, 2011

(51) Int. Cl. G02B 27/22

(52) U.S. Cl. 250/347

(57) ABSTRACT

Provided is a 3D eyeglass of a shutter type. In the 3D eyeglass, a case in which infrared ray shielding surface is formed is provided on a front surface of a 3D eyeglass sensor, and a telephoto lens for telescoping and collecting light is provided on an inner-front surface of the case wherein a diameter of the telephoto lens is 1.5 times great as or greater than a diameter of the sensor to increase a collecting capability of infrared ray to 1.5 times as a prior art, and a focal point distance of the telephoto lens is 2-40 mm and is movable for the sensor to be focused on a screen at remote distance. Accordingly, infrared ray interference from an external light can be avoided and 3D signal on a specific picture can be amplified and sensed, and thereby viewing a clear 3D images.

### BACKGROUND OF THE INVENTION

1. Field of the Invention

The present invention relates to a 3D eyeglass and more particularly, to a 3D eyeglass in which a left-right synchronizing signal sensing range is defined and the sensed synchronizing signal within the range is amplified with respect to a active shutter-type glass.

2. Description of the Related Art

In general, it has been known that in a 3D eyeglass configuration, a passive type uses a polarization plate and a shutter type in which left-right part of a eyeglass are opened.

In a 3D eyeglass of the shutter type (Hereinafter, refer to as “3D eyeglass”), corresponding to the left image and right image projected alternatively per 1/60 second from a projector, among all of the images which are projected from the projector, the left and right eyeglasses are opened alternatively and thus only the left image can be viewed on a left eye of a viewer through the left eyeglass when the left image is projected on a screen and further only the right image can be viewed on a right eye of a viewer through the right eyeglass when the right image is projected on a screen.

Further, in a 3D TV such as 3D PDP TV (Hereinafter, referred to as “3D TV”), a separate emitter may be attached to a TV and left-right image signals which are exchanged in the 3D TV may be send to a infrared ray sensor arranged in a eyeglass. However, during this process, when the driving synchronizations of the left and right images projected from a projector are not corresponded to the shutter driving of the left and right eyeglasses, the 3D image cannot be viewed. In order to make a synchronization of the left and right images and the left and right eyeglasses, a synchronization signal loaded on infrared rays is sent to a screen from a projector or a 3D TV and then a photosensitive sensor for an infrared ray provided in a 3D eyeglass receives the signal to be synchronized with the left and right images on a 3D screen or 3D TV.

However, the photosensitive sensor for an infrared ray provided in a 3D eyeglass may be interrupted by other infrared rays produced from external lights of surrounding light, etc. In particular, the photosensitive sensor for an infrared ray may be malfunctioned due to signals of some infrared rays provided from a fluorescent lamp and thus the synchronization of the images and the eyeglasses are impossible.

Further, in a case where several 3D TV and 3D screens are operated simultaneously at a sport bar, exhibition center or public computer room or game room, in a prior 3D eyeglass, several synchronizing signals sent from several images are received simultaneously and confused and thus 3D images cannot viewed.

Additionally, in the shutter type 3D eyeglass, in a case where a travel distance of the synchronizing signal exceeds 6-7 m, strength of the synchronizing signal is weakened and thereby not being sensed by a sensor provided in a 3D eyeglass.

### SUMMARY OF THE INVENTION

An object of the present invention is directed to provide a 3D eyeglass in which by defining synchronizing signals of infrared rays of 3D images sent from several 3D TV or 3D screens and sensing them, a confusion thereof can be avoided, and by amplifying a synchronizing signals of infrared ray signal from a remote 3D screen and sensing them, 3D image viewing distance can be enlarged, and by synchronizing both focal points of a specific 3D screen and an infrared ray sensor provided in a 3D eyeglass, only a signal of the specific 3D screen can be sensed.

One aspect of the present invention is directed to provide a 3D eyeglass comprising a telephoto lens a front portion of a sensor provided in a 3D eyeglass wherein the telephoto has a size of 1.5 times as or greater than a diameter of the sensor and a focal point distance thereof is equal to or within a case length, and further the telephoto lens is provided within a case provided inside with a infrared ray shielding member, and the focal point distance is movable frontward and rearward, corresponding to a location of a 3D screen.

According to the present invention, a synchronizing signal of an infrared ray sent from a predetermined direction may be concentrated in a double intensity through a telephoto lens provided inside a case and only the synchronizing signal of a infrared ray sent from a specific screen selected among several 3D screens can be amplified and sensed and thus left and right synchronizing signals are not confused with signals from other 3D screens and obviously amplified and received. Meanwhile, The focal point of the telephoto lens is focused on an image of a 3D screen at a remote distance and at the same time focused on a sensor and thereby sensing synchronizing signals even at 4 times remote distance as a prior art.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a perspective view illustrating a 3D eyeglass according to the present invention;

FIG. 2 is a perspective view illustrating a configuration of a telephoto lens according to the present invention;

FIG. 3 is a view illustrating an operation of the telephoto lens according to the present invention;

FIG. 4 is a view illustrating external light for showing on operation of the 3D eyeglass according to the present invention; and

FIG. 5 is a view illustrating an operation of a 3D screen configured according to the present invention.

### REFERENCE NUMERALS

1: eyeglass

2: telephoto lens

3: left shutter

4: right shutter

5: sensor

6: case

7: shielding member

8: movable case

9: 3D screen

### DETAILED DESCRIPTION OF EXEMPLARY EMBODIMENTS

Exemplary embodiments of the present invention will be described below in detail with reference to the accompanying drawings. Wherever possible, the same reference numerals will be used to refer to the same elements throughout the specification, and a duplicated description thereof will be omitted.

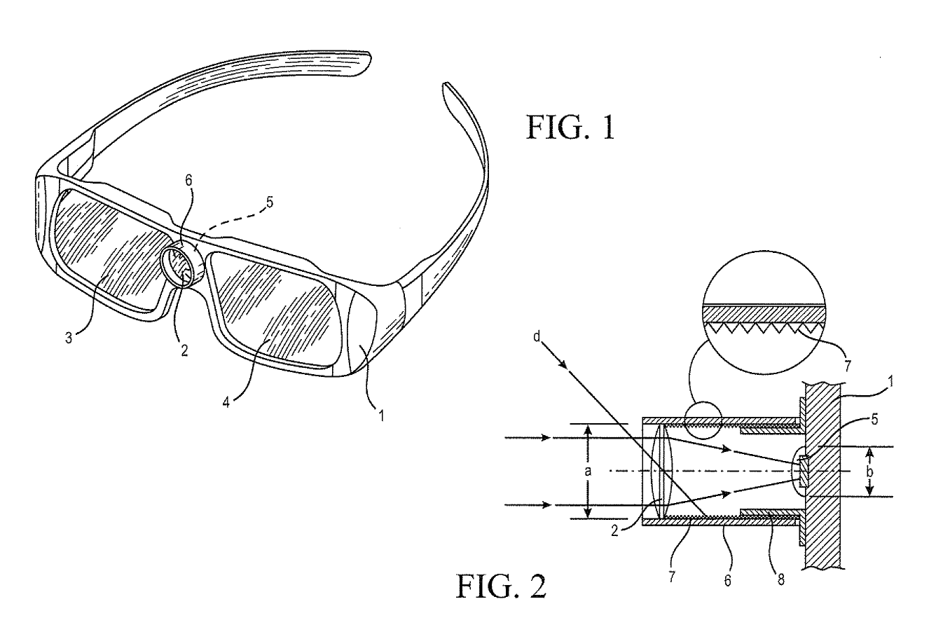

As shown in FIGS. 1 and 2, a case may be provided between a left shutter 3 and a right shutter 4 and a telephoto lens 2 may be provided on an inner-front surface of the case, through which telescoping a remote distance and collecting light can be performed simultaneously.

Meanwhile, as shown in FIG. 2, a shielding member 7 for shielding an infrared ray may be provided inside the case 6, and if necessary, a movable case 8 through which the telephoto lens 2 is moved frontward and rearward may be provided on a front surface of a sensor 5 of a eyeglass 1.

Such the case 6 could be positioned in the center, right or left of the eye glass 1.

Here, a diameter a of the telephoto lens 2 may be 1.5 times as or greater than a diameter b of the sensor 5 since the telephoto lens 2 as 1.5 times large as the sensor 5 can collect infrared ray of about two times or more(1.5²=2.25=about 2), and sense it.

Accordingly, in a case where the eyeglass 1 is directed to a 3D screen 9, the telephoto lens can collect the two times or more synchronizing signals of infrared rays (Hereinafter, referred to as “synchronizing signal”) sent from the direction and sense them.

A focal point distance of the telephoto lens 2 may be less than 2-40 mm wherein it may be varied depending on a diameter of lens within the range of 2-4 mm. In a case where the focal point distance is less than 2 mm, a caliber of the telephoto lens becomes smaller and thus light collecting efficiency is decreased, and in a case where the focal point distance is greater than 40 mm, a projected area becomes larger when the telephoto lens is connected to the eyeglass 1 and thus it is not to be practical. That is, when the telephoto lens 2 as configured in the forgoing is moved in the case 6, the telephoto lens can collect the synchronizing signals incident from a remote distance and send the collected synchronizing signals to a surface of the sensor 5.

Here, there may be a first focal point on a front surface of the telephoto lens and a second focal point on a rear surface thereof. Additionally, a relation between the first and second focal points is as followings.

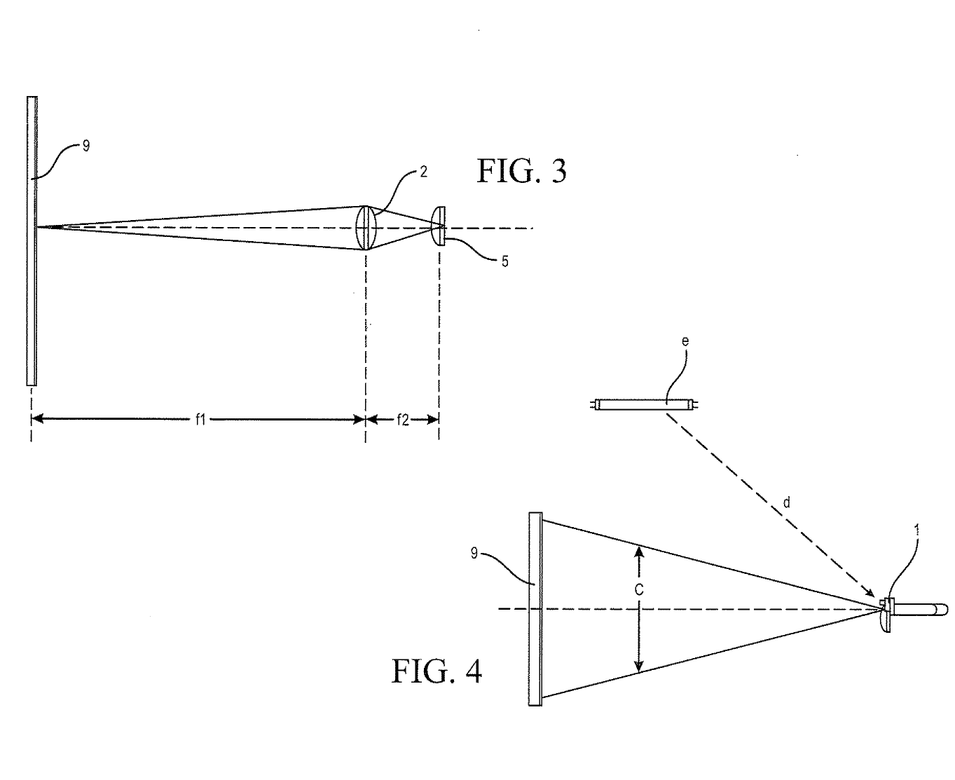

When a focal point distance of the telephoto lens is F, F=1/f1+1/f2. Accordingly, as shown in FIG. 3, the telephoto lens placed inside the case 6 is moved in the movable case 8 to focus on the first focal point of the telephoto lens 2 with an image of a 3D screen 9 placed at remote distance and at the same time to focus on the second focal point of the telephoto lens 2 with the sensor 5, and thus senses only the synchronizing signals of a specific image of a remote distance.

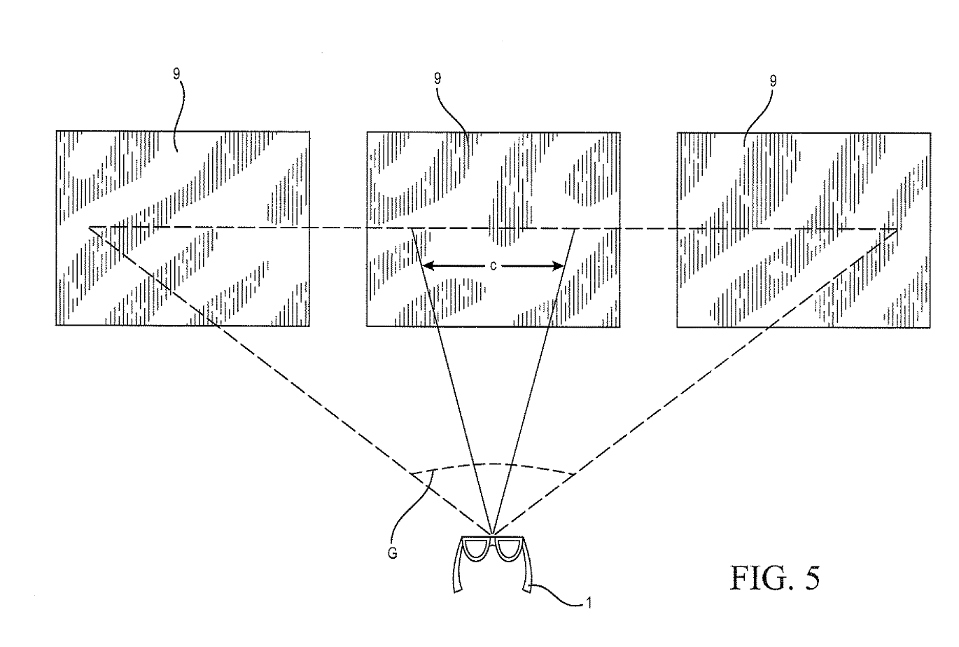

Meanwhile, as shown in FIG. 2, the telephoto lens 2 arranged inside the case 6 may collect the two times or more synchronizing signals of infrared rays from the 3D screen 9 within a defined range c, and send the collected synchronizing signals to the sensor 5, as shown in FIGS. 4 and 5.

Further, as shown in FIGS. 2 and 4, external light d incident to the telephoto lens 2 from a fluorescent lamp at a wide angle is shielded by the shielding member 7 inside the case 6 and other signals are prevented from being incident to the sensor 5 for an infrared ray. Here, the synchronizing signal of an infrared ray uses infrared rays sent from a screen as a signal and thus the shielding member 7 for shielding the external light may be configured to prevent other infrared rays sent from other places, instead of from the screen. As a result, a physical shape of the shielding member may be a thread form, as shown in FIG. 2.

Through this configuration, the telephoto lens is focused on only one 3D screen 9 among several images displayed on a 3D screen by rotating the case 6, as shown in FIG. 5, and thus one synchronizing signal among several synchronizing signals sent from a surrounding light or several pictures is selected and then the selected synchronizing signal of the 3D screen 9 focused on a focal point of the telephoto lens is collected two times.

Therefore, the synchronizing signals of the 3D screen 9 placed even at remote distance of 20 m as 4 times as a prior art, as shown in FIG. 4, can be viewed obviously without interference of external light d.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1-5. (canceled)

6. A 3D eyeglass of a left and right shutter type, comprising:
an infrared light sensor provided between a left shutter and a right shutter of the eyeglass;
a case having an inner front area connected to the sensor in front of the sensor;
an infrared light shield provided within the case; and
a movable telephoto lens configured and arranged to collect and focus light on the sensor disposed at the inner-front area of the case.

7. The 3D eyeglass of a left and right shutter type of claim 6, wherein the telephoto lens and the sensor have respective diameters, and wherein the diameter of the telephoto lens is 1.5 times greater than the diameter of the sensor.

8. The 3D eyeglass of a left and right shutter type of claim 6, wherein a focal distance of the telephoto lens is 2-40 mm.

9. The 3D eyeglass of a left and right shutter type of claim 6, wherein a portion of the case to which the telephoto lens is connected is movable frontward and rearward relative to the sensor so that a first focal point of the telephoto lens is focused on a 3D screen at a remote distance or a screen of a 3D TV, and a second focal point of the telephoto lens is focused on the sensor.

10. The 3D eyeglass of a left and right shutter type of claim 6, wherein the case comprises a front and rear portion threadedly connected together, with the telephoto lens connected to the front portion, and wherein the shielding surface comprises a portion of the threaded connection.
